(19) United States
(12) Patent Application Publication
(10) Pub. No.: US 2012/0109990 A1
(43) Pub. Date: May 3, 2012

(54) INFORMATION SEARCH SYSTEM, INFORMATION MANAGEMENT DEVICE, INFORMATION SEARCH METHOD, INFORMATION MANAGEMENT METHOD, AND RECORDING MEDIUM

(75) Inventor: Kentaro Yamasaki, Tokyo (JP)

(73) Assignee: NEC CORPORATION, Tokyo (JP)

(21) Appl. No.: 13/382,565

(22) PCT Filed: Jul. 7, 2010
(86) PCT No.: PCT/JP2010/061547

§ 371 Date: Jan. 6, 2012

(30) Foreign Application Priority Data
Jul. 7, 2009 (JP) 2009-160642

(51) Int. Cl. G06F 17/30

(52) U.S. Cl. 707/758; 707/E17.014

(57) ABSTRACT

An evaluation target information processing means (15) inputs evaluation target information having M attribute information items. A combination generating means (14) extracts and combines 1 to M attribute information items from the evaluation target information to generate combinations. An attribute information linking means (12) generates, for each of the combinations, a link attribute value to which the attribute values of the attribute information items are linked. A hash generation means (13) converts the link attribute value to a hash value. A hash table (19) stores registered information so as to correspond to the hash value corresponding to the registered information. An information searching means (18) searches the hash table (19) and extracts registered information registered so as to correspond to the hash value that matches any of the hash values converted by the hash generation means (13).

### TECHNICAL FIELD

The present invention relates to an information search system, an information management device, an information search method, an information management method and a recording medium, and more particularly to an information search system, an information management device, an information search method, an information management method and a recording medium that accomplish searches for registered information using hash values.

### BACKGROUND ART

An information search system is a system that extracts information matching desired conditions from registered information. Patent Literature 1 is a document that describes an information search system (device). The search device described in Patent Literature 1 has a memory unit, a key hash computation unit and a search unit. The memory unit has an original data region and an index region. The data region is a region for storing original data groups. The index region is a region for storing information indicating the storage location of the original data. Information indicating the storage location of each original data item in the original data region is stored in a location in the index region corresponding to the hash value of this original data.

When searching, the key hash computation unit computes a hash value of the search key. The search unit references the location corresponding to the hash value of the search key in the index region and extracts the storage location of the original data. Following this, the search unit extracts the desired original data from the location indicated by the storage location of the extracted original data in the original data region. In general, in an information search the time needed for searching is longer the more information is targeted by the search. Patent Literature 1 extracts data matching the search key using a hash value, yielding the result that the search can be accomplished at a high speed even if the information volume increases.

Patent Literature 2 is a document describing a data analysis method. In Patent Literature 2, network packet information such as the sender's address, recipient's address, port number and so forth is input and combinations of addresses and ports common on the network are extracted. With Patent Literature 2, for example, a cache for one item, a cache for two items and a cache for three items are used for data of three items. The cache for one item stores the hash value of one data item and the occurrence frequency of that data. The cache for two items stores the hash values of two data items and the occurrence frequency of combinations of the two data items. The cache for three items stores the hash values of three data items and the occurrence frequency of combinations of the three data items.

For example, suppose that the data of 192.168.0.1 (sender's address), 192.168.1.1 (recipient's address) and 25 (port number) are input into the analysis device described in Patent Literature 2. The analysis device converts “192.168.0.1”, “192.168.1.1”, and “25” into hashes. The analysis device looks up whether or not the hash value of “192.168.0.1”, the hash value of “192.168.1.1” and the hash value of “25” are already stored in the cache table for item 1. If corresponding hash values are not stored, the analysis device records the hash values of those data items as new items in the cache table as a first occurrence. When these have already been recorded, the analysis device increments the occurrence count of the hash values of these data items.

In addition, the analysis device looks up whether or not the combination of the hash value of “192.168.0.1” and the hash value of “192.168.1.1”, and the combination of the hash value of “192.168.0.1” and the hash value of “25”, and the combination of the hash value of “192.168.1.1” and the hash value of “25”, in which two of the three data items have been selected, have already been recorded in the cache table for two items. When these have already been recorded, the analysis device increments the occurrence count of these combinations. Furthermore, the analysis device looks up whether or not the combination of the hash value of “192.168.0.1”, the hash value of “192.168.1.1” and the hash value of “25” has already been recorded in the cache table for three items, and when such has not already been recorded, increments the occurrence count for this combination.

### PRIOR ART LITERATURE

### Patent Literatures

Patent Literature 1: Unexamined Japanese Patent Application KOKAI Publication No. 2007-241378 (FIG. 1)
Patent Literature 2: Unexamined Japanese Patent Application KOKAI Publication No. 2005-285048

### SUMMARY OF INVENTION

### Problems to be Solved by the Invention

Consider managing registered information including one or more attribute information items using a hash table, and performing an information search. Suppose that there are a total of N types of attribute information that can be contained in the registered information, that all N types of attribute information need not possess data (attribute values) and that a portion of the attribute information can be omitted. For example, consider registered information containing the attribute information of attribute name: age, attribute name: sex and attribute name: location. The registered information would appear as {(age, 20s), (sex, M), (location, Tokyo)}, and need not contain all attribute information, or may be {(age, 20s), (sex, M)} with the attribute name: location omitted. Omitted attribute information may be processed as being arbitrary.

Consider the case where the registered information {(age, 20s), (sex, M)} is registered in the system and {(age, 20s), (sex, M), (location: Tokyo)} is given as evaluation target information. In this case, the registered information of {(age, 20s), (sex, M)} is such that attribute information other than age and sex can be arbitrary, so the evaluation target information {(age, 20s), (sex, M), (location: Tokyo)} is a match. However, because {(age, 20s), (sex, M)} and {(age, 20s), (sex, M), (location: Tokyo)} are different information, the hash values created based on each would be markedly different. Consequently, when the system manages the registered information using a hash table, even if the hash table were searched on the basis of a hash value created on the basis of {(age, 20s), (sex, M), (location: Tokyo)}, that hash value would not match the hash value created on the basis of {(age, 20s), (sex, M)}, so it would be impossible to extract entries containing that registered information.

As described above, when the number of attribute information items contained in the evaluation target information and the number of attribute information items in the registered information do not match, hash values created on the basis of these differ markedly. Consequently, it is impossible to search for registered information including wild cards showing that attribute values may be arbitrary from a hash table using that kind of evaluation target information. In general, information searches using hash tables can be said to be effective and can be operated at high speed when accomplishing a complete match search. However, information searches using hash values are not complete match searches because converting the information into a hash value causes the meaning of the information and the continuity to be lost, so it is difficult to conduct a search at high speed for multiple information items having a continuous relationship or an inclusive relationship.

The analysis method described in Patent Literature 2 is nothing more than simply using a combination of hash values to search for whether or not a the occurrence count for a data combination has already been recorded in a cache table. Accordingly, the analysis method described in Patent Literature 2 cannot resolve the above-described problems in information searches using hash tables.

In consideration of the foregoing, it is an object of the present invention to provide an information search system, an information management device, an information search method, an information management method and a recording medium that can search for registered information matching evaluation target information not containing wild cards, even when the registered information contains the wild card that attribute values may be arbitrary.

### Means for Solving the Problem

In order to achieve the above object, the present invention provides an information search system, comprising: an evaluation target information processing means for inputting evaluation target information having M (where M is 1 or more and an integer) items of attribute information containing attribute values; a combination generating means for generating combinations made by picking out and combining 1 to M attribute information items from the evaluation target information input into the evaluation target information processing means; an attribute information linking means for generating linked attribute values linking attribute values of the attribute information contained in each combination, for the combinations generated by the combination generating means; a hash generating means for converting linked attribute values generated by the attribute information linking means into hash values; and an information searching means for searching a hash table in which registered information having one or more attribute information item is stored so as to correspond to hash values converted from the linked attribute values linking the attribute values of attribute information contained in the registered information, and extracting registered information registered so as to correspond to hash values that match any of the hash values converted by the hash generating means.

The present invention provides 7 an information search system, comprising: a registered information processing means for inputting registered information having one or more attribute information item containing an attribute value; a combination generating means for referencing a pattern storage unit that stores attribute values of attribute information handled as registered information, generating a supplemental pattern composed of combinations of attribute values of attribute information not contained in the registered information input into the registered information processing means, out of the attribute information handled as registered information, and generating supplemental attribute information in which the supplemental pattern is added to the registered information; an attribute information linking means for generating linked attribute values linking attribute values of attribute information contained respectively in the registered information and the supplemental attribute information; a hash generating means for converting linked attribute values generated by the attribute information linking means into hash values; an information registering means for registering the registered information in a hash table so as to correspond to hash values converted by the hash generating means; an evaluation target information processing means for inputting evaluation target information containing one or more attribute information item and for generating an information search request containing hash values that are linked attribute values linking attribute values contained in the input evaluation target information using the attribute information linking means, converted using the hash generating means; and an information searching means for searching the hash table and extracting registered information registered so as to correspond to hash values matching hash values contained in the information search request.

The present invention provides an information management device, comprising: a registered information processing means for inputting registered information having one or more attribute information item containing an attribute value; a combination generating means for referencing a pattern storage unit that stores attribute values of attribute information handled as registered information, generating a supplemental pattern composed of combinations of attribute values of attribute information not contained in the registered information input into the registered information processing means, out of the attribute information handled as registered information, and generating supplemental attribute information in which the supplemental pattern is added to the registered information; an attribute information linking means for generating linked attribute values linking attribute values of attribute information contained respectively in the registered information and the supplemental attribute information; a hash generating means for converting linked attribute values generated by the attribute information linking means into hash values; and an information registering means for registering the registered information in a hash table so as to correspond to hash values converted by the hash generating means.

The present invention provides an information search method, comprising: a combination generating step in which a computer generates combinations made by picking out and combining 1 to M attribute information items from evaluation target information having M (where M is 1 or more and an integer) items of attribute information containing attribute values; an attribute information linking step in which the computer generates linked attribute values linking attribute values of the attribute information contained in each combination, for each generated combination; a hash generating step in which the computer converts linked attribute values generated in the attribute information linking step into hash values; and an information searching step in which the computer searches a hash table in which registered information having one or more attribute information item is stored so as to correspond to hash values converted from the linked attribute values linking the attribute values of attribute information contained in the registered information, and extracts registered information registered so as to correspond to hash values that match any of the hash values converted by the hash generating step.

The present invention provides an information search method, comprising: a supplemental pattern generating step in which a computer inputs registered information having one or more attribute information item containing an attribute value, and generates a supplemental pattern composed of combinations of attribute values of attribute information not contained in the registered information input into the registered information processing means, out of the attribute information handled as registered information, with reference to a pattern storage unit that stores attribute values of attribute information handled as registered information; an attribute information linking step in which the computer generates linked attribute values linking attribute values of attribute information contained respectively in the registered information and the supplemental attribute information in which the supplemental pattern is added to the registered information; a hash conversion step in which the computer converts linked attribute values generated by the attribute information linking step into hash values; an information registering step in which the computer registers the registered information in a hash table so as to correspond to hash values converted in the hash generating step; an evaluation target information hash conversion step in which the computer inputs evaluation target information containing one or more attribute information item and converts linked attribute values linking attribute values contained in the input evaluation target information into hash values; and an information searching step in which the computer searches the hash table and extracts registered information registered so as to correspond to hash values matching hash values generated in the evaluation target information hash conversion step.

The present invention provides an information management method, comprising: a supplemental pattern generating step in which a computer inputs registered information having one or more attribute information item containing an attribute value, and generates a supplemental pattern composed of combinations of attribute values of attribute information not contained in the input registered information, out of the attribute information handled as registered information, with reference to a pattern storage unit that stores attribute values of attribute information handled as the registered information; an attribute information linking step in which the computer generates linked attribute values linking attribute values of attribute information contained respectively in the registered information and the supplemental attribute information in which the supplemental pattern is added to the registered information; a hash conversion step in which the computer converts the linked attribute values generated in the attribute information linking step into hash values; and an information registering step in which the computer registers the registered information in a hash table so as to correspond to hash values converted in the hash conversion step.

The present invention provides a computer-readable recording medium on which is recorded a program that causes a computer to execute: a combination generating process for generating combinations made by picking out and combining 1 to M attribute information items from evaluation target information having M (where M is 1 or more and an integer) items of attribute information containing attribute values; an attribute information linking process for generating linked attribute values linking attribute values of the attribute information contained in each combination, for each of the generated combinations; a hash conversion process for converting linked attribute values generated by the attribute information linking process into hash values; and an information searching process for searching a hash table in which registered information having one or more attribute information item is stored so as to correspond to supplemental attribute information in which linked attribute values linking attribute values of attribute information contained in the registered information is converted into hash values, and extracting registered information registered so as to correspond to hash values that match any of the hash values converted by the hash conversion process.

The present invention provides a computer-readable recording medium on which is recorded a program that causes a computer to execute: a supplemental pattern generating process for inputting registered information having one or more attribute information item containing an attribute value, and generating a supplemental pattern composed of combinations of attribute values of attribute information not contained in the input registered information, out of the attribute information handled as registered information, with reference to a pattern storage unit that stores attribute values of attribute information handled as registered information; an attribute information linking process for generating linked attribute values linking attribute values of attribute information contained respectively in the registered information and the supplemental attribute information in which the supplemental pattern is added to the registered information; a hash conversion process for converting linked attribute values generated by the attribute information linking process into hash values; an information registering process for registering the registered information in a hash table so as to correspond to hash values converted by the hash generating process; an evaluation target information hash conversion process for inputting evaluation target information containing one or more attribute information item and converting linked attribute values linking attribute values contained in the input evaluation target information into hash values; and an information searching process for searching the hash table and extracting registered information registered so as to correspond to hash values matching hash values generated by the evaluation target information hash conversion process.

The present invention provides a computer-readable recording medium on which is recorded a program that causes a computer to execute: a supplemental pattern generating process for inputting registered information having one or more attribute information item containing an attribute value, and generating a supplemental pattern composed of combinations of attribute values of attribute information not contained in the input registered information, out of the attribute information handled as registered information, with reference to a pattern storage unit that stores attribute values of attribute information handled as registered information; an attribute information linking process for generating linked attribute values linking attribute values of attribute information contained respectively in the registered information and the supplemental attribute information in which the supplemental pattern is added to the registered information; a hash conversion process for converting linked attribute values generated by the attribute information linking process into hash values; and an information registering process for registering the registered information in a hash table so as to correspond to hash values converted by the hash generating process.

### Effect of the Invention

The information search system, information management device, information search method, information management method and recording medium of the present invention can search for registered information matching evaluation target information not containing wild cards, even when the registered information contains the wild card that attribute values may be arbitrary.

### BRIEF DESCRIPTION OF DRAWINGS

FIG. 1 is a block diagram showing an information search system according to a first embodiment of the present invention.

FIG. 2 shows the data structure of registered information and evaluation target information.

FIG. 3 is a flowchart showing the operation sequence of information registration.

FIG. 4 is a flowchart showing the operation sequence of information evaluation.

FIG. 5 shows a concrete example of combinations of attribute information.

FIG. 6 shows the evaluation target information received by an information search system according to a second embodiment of the present invention.

FIG. 7 shows combinations of evaluation target information generated by the information search system according to the second embodiment.

FIG. 8 is a block diagram showing an information search system according to a third embodiment of the present invention.

FIG. 9 shows an example of data in a pattern recording unit and an example of data of the supplement pattern created by the combination generating unit.

FIG. 10 is a flowchart showing the operation sequence of information registration in the third embodiment.

FIG. 11 is a flowchart showing the operation sequence of information evaluation in the third embodiment.

### BEST MODE FOR CARRYING OUT THE INVENTION

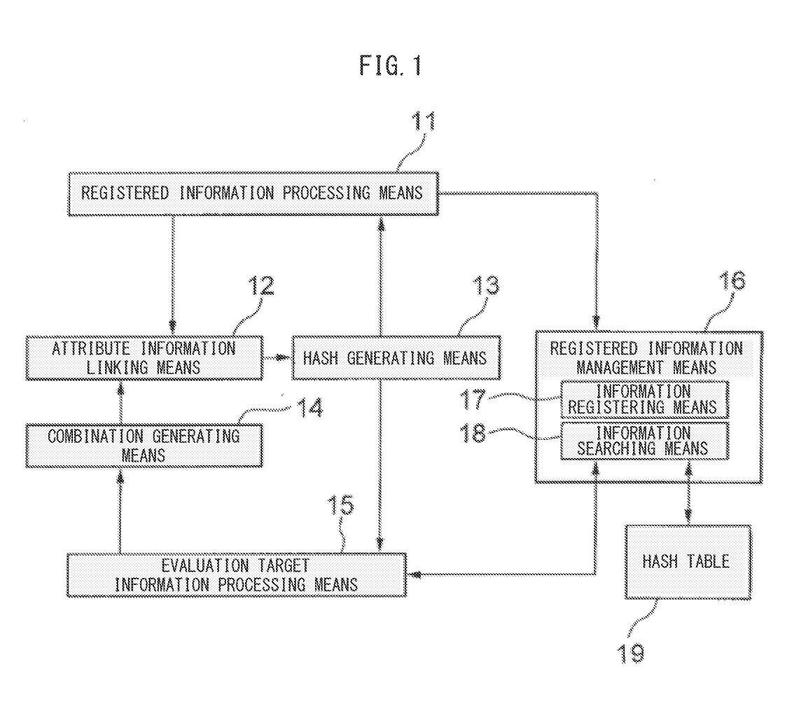

Below, the preferred embodiments of the present invention are described in detail with reference to the drawings. FIG. 1 shows an information search system according to a first embodiment of the present invention. The information search system has a registered information processing means 11, an attribute information linking means 12, a hash generating means 13, a combination generating means 14, an evaluation target information processing means 15, and a registered information management means 16. The functions of each of these means within the information search system can be realized by executing a prescribed program on a computer system.

The registered information processing means 11 receives registration information including one or more attribute information items. The registered information processing means 11 sends an information registration request to the registered information processing means 16 and requests storing of the registered information.

The evaluation target information processing means 15 receives evaluation target information including one or more attribute information items. The evaluation target information processing means 15 sends a search request to the registered information processing means 16 and requests searching of information on the basis of the evaluation target information.

The registered information processing means 16 registers information and accomplishes searches for registered information.

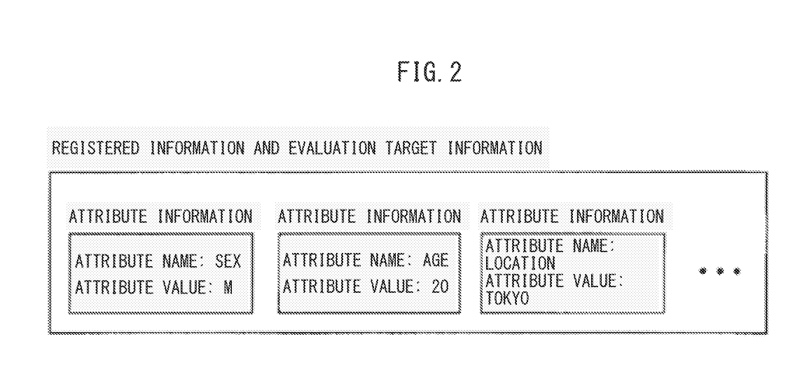

FIG. 2 shows the data structure of registered information and evaluation target information. The registered information and evaluation target information are composed of one or more attribute information items. Each attribute information item includes an attribute name and an attribute value. Suppose that the attribute information handled by the information system consists of a total of N types (where N is 2 or more and an integer), and the registered information need not have attribute values for all N types of attribute information. A portion of the attribute information items may be omitted. The omitted attribute information items can be interpreted as having arbitrary values. The same is true for the evaluation target information as well.

The combination generating means 14 receives evaluation target information from the evaluation target information processing means 15, and generates combinations picking out 1 to M items from the M attribute information items (where M is 1 or more and N or less, and an integer) contained in the evaluation target information. If M=3, for example, the combination generating means 14 generates combinations (3 combinations) picking out one of the three attribute information items contained in the evaluation target information, combinations (3 combinations) picking out and combining two attribute information items from the three attribute information items, and combinations (1 combination) picking out and combining three attribute information items from the three attribute information items, giving a total of 10 combinations. These combinations are used as evaluation target information when performing information searches.

The attribute information linking means 12 generates linked attribute values linking attribute information items containing registered information and evaluation target information. At this time, the attribute information linking means 12 links attribute information by putting the attribute information in a prescribed order. Here, the attribute information linking means links attribute values of attribute information items contained in each combination generated by the combination generating means 14 for the evaluation target information.

The hash generating means 13 converts the registered information or evaluation target information (combinations) to which the attribute information is linked by the attribute information linking means 12 into hash values. A typical hash function such as MD5 or SHA can be used for hash conversion in the hash generating means 13.

The registered information management means 16 has an information registering means 17 and an information searching means 18. The registered information management means 16 accomplishes information management using a hash table 19.

The hash table 19 stores registered information so as to correspond to hash values generated on the basis of linked attribute values linking attribute values contained in the registered information.

The information registering means 17 receives an information registration request from the registered information processing means. The information registering means 17 stores the registered information in the hash table 19 so as to correspond to hash values for registered information converted by the hash generating means 13. More specifically, the information registration means 17, upon receiving an information registration request, creates an entry quantifying the registered information in the hash table 19 with the hash value as a key, and stores the registered information in the hash table 19.

The information searching means 18 receives an information search request from the evaluation target information processing means 15. The information searching means 18, upon receiving an information search request, searches the hash table 19, and extracts registered information registered so as to correspond to hash values that match one of the hash values of the evaluation target information generated by the hash generating means 13 (hash values corresponding to combinations generated by the combination generating means 14).

The behavior of information search systems can be broadly divided into information registration flow that registers information, and information evaluation flow that searches for registered information matching the evaluation target information.

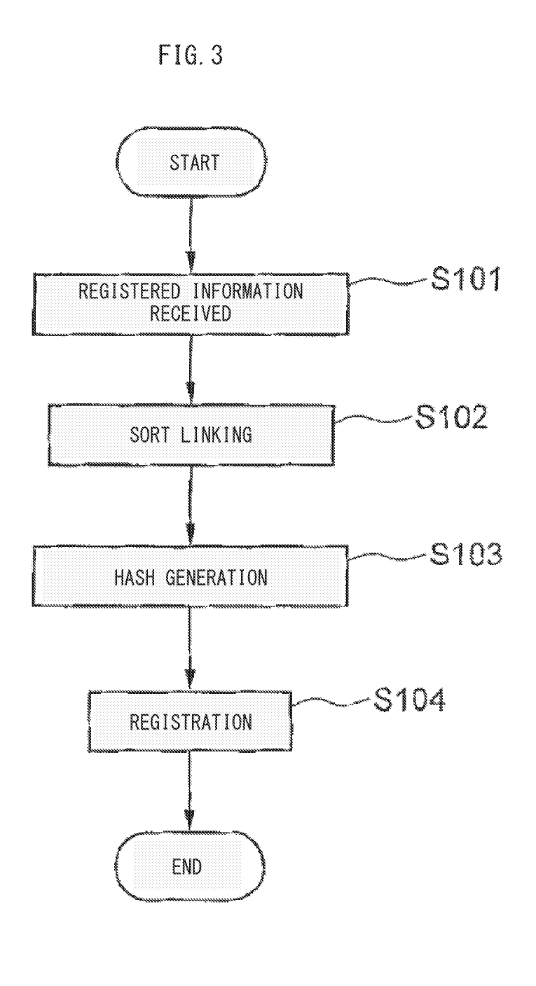

First, the information registration flow will be described. FIG. 3 shows the operation sequence for information registration. Below, this is explained with reference to the drawing.

The registered information processing means 11 receives registration information containing one or more attribute information items (step S101). The registered information processing means 11 upon receiving the registered information passes the registered information received to the attribute information linking means 12.

For example, supposed that there are N types of attribute information handled by the information search system, including age, sex and location. The registered information processing means 11 may receive registered information containing all N types of attribute information, or may receive attribute information containing only the three types of attribute information of age, sex and location. Among the N types of attribute information, the attribute information not included in the registered information is treated as a wild card indicating that the value may be anything. The information search system need not know in advance the N types of attribute information that could be received. In addition, the ordering of attribute information in the registered information may be arbitrary.

The attribute information linking means 12, upon receiving registered information from the registered information processing means 11, extracts attribute information from the registered information and generates a linked attribute value linking attribute information in a prescribed order (step S102). The attribute information linking means 12 for example orders the attribute information on the basis of attribute name. The order can be thought of as alphabetic order, or syllabary order, or ascending or descending numerical order. Or, a setting file determining the ordering can be prepared in advance in the attribute information linking means 12 and ordering may be accomplished in accordance with this setting file. The attribute information linking means 12 for example sorts the registered information of {(age, 20), (sex, F), (location, Tokyo)} by attribute name in syllabary order and generates a linked attribute value of “F20Tokyo”. The attribute information linking means 12 passes this linked attribute values to the hash generating means 13.

The hash generating means 13, upon receiving the linked attribute information from the attribute information linking means 12, converts the received linked attribute values into hash values (step S103). The hash values generated by step S103 correspond to the hash values of the registered information. The hash generating means 13 passes the converted attribute information hash values to the registered information processing means 11. Upon receiving the hash values of converted registered information, the registered information processing means 11 sends to the registered information management means 16 an information registration request including the received hash values and the registered information. Upon receiving the information registration request, the information registration means 17 of the registered information management means 16 generates an entry whose value is the registered information in the hash table 19 with the hash value contained in the information registration request as the key (step S104).

When the entry is registered in the hash table 19, the information registration means 17 looks to see whether or not an entry having the same hash value as the key already exists. When an entry with the same hash key exists, the information registration means 17 conducts list management with this as an entry having the same hash key. In the information search system, by accomplishing information registration in the order shown in FIG. 3, a single hash value is generated and registered information is managed with a hash table 19 for registered information containing the wild card that any value is fine in the attribute information.

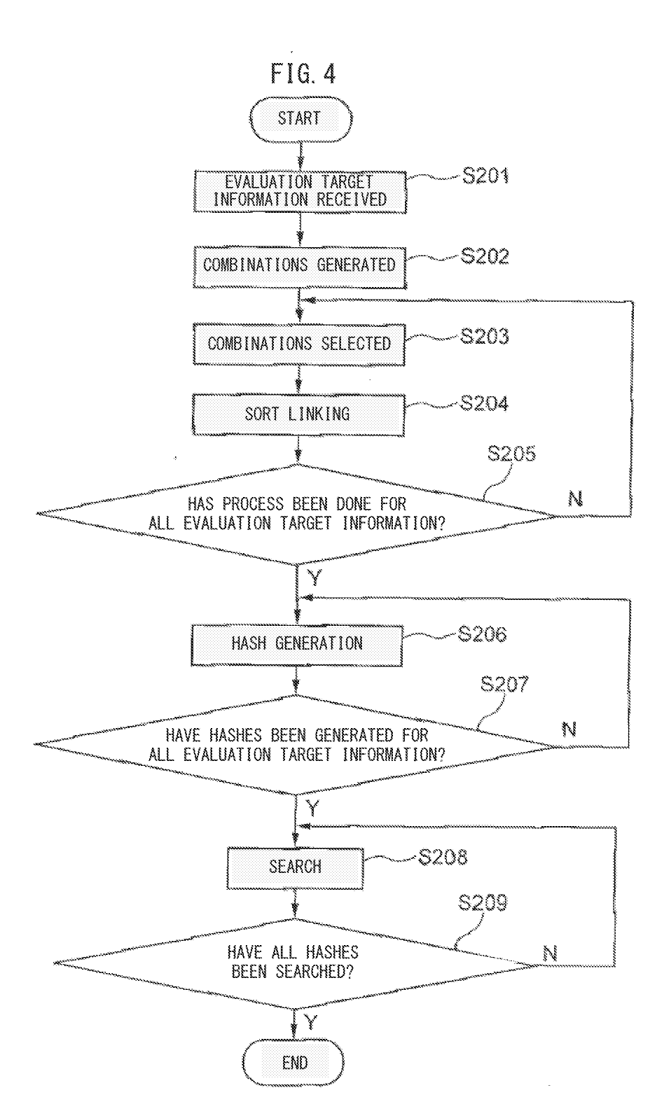

Next, the information evaluation flow will be described. FIG. 4 shows the operation sequence for information evaluation. Below, this is described with reference to this drawing.

The evaluation target information processing means 15 receives evaluation target information including one or more attribute information items (step S201). The evaluation target information processing means 15 passes the received evaluation target information to the combination generating means 14.

Upon receiving the evaluation target information from the evaluation target information processing means 15, the combination generating means 14 extracts attribute information from the evaluation target information and generates combinations of attribute information contained in the evaluation target information (step S202). The combination generating means 14 in step S202 generates combinations of 1 to M selected attribute information items from the M attribute information items extracted and makes these the new evaluation target information.

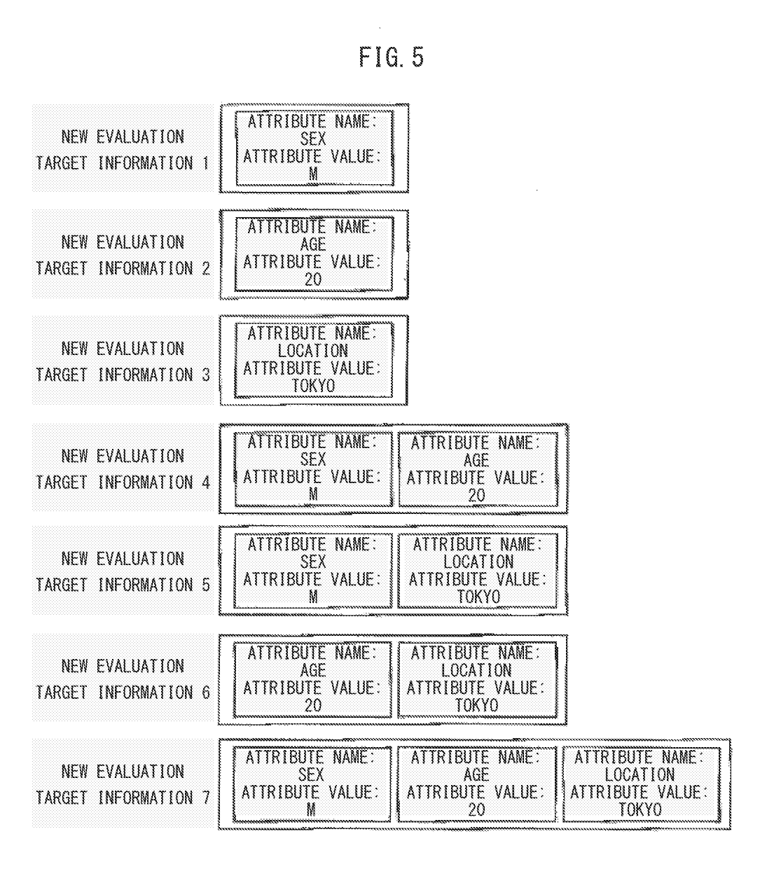

FIG. 5 shows an example of combinations of attribute information. Suppose that the evaluation target information received by the evaluation target information processing means 15 contains three attribute information items (attribute information 1 (attribute name: age; attribute value: 20), attribute information 2 (attribute name: sex; attribute value) and attribute information 3 (attribute name: location; attribute value: Tokyo). Suppose that the combination generating means 14 makes three combinations of one item selected from the three attribute information items, namely {(age: 20)}, {(sex: M)}, and {(location: Tokyo)} into new evaluation target information items 1 to 3. In addition, suppose that the combination generating means 14 makes three combinations of two items selected from the three attribute information items, namely {(age: 20), (sex: M)}, {(age: 20), (location: Tokyo)} and {(sex: M), (location: Tokyo)} into new evaluation target information items 4 to 6, and makes one combination of three items selected from the three attribute information items, namely {(age: 20), (sex: M), (location: Tokyo)}, into a new evaluation target information item 7.

The combination generating means 14 selects one of the combinations of attribute information (new evaluation target information) generated in step S202, and sends the selected evaluation target information to the attribute information linking means 12 (step S203).

The attribute information linking means 12 extracts attribute information from the evaluation target information received from the combination generating means 14, generates a linked attribute value in which the extracted attribute information is arranged in a prescribed order and linked (step S204). For example, the attribute information linking means 12 receives new attribute information item 7 {(age: 20), (sex: M), (location: Tokyo)} of FIG. 5, sorts the attribute name in syllabary order, and generates a linked attribute value of “M20Tokyo” in which the attribute values are linked in “sex”, “age”, “location” order.

The combination generating means 14 determines whether or not the new evaluation target information generated in step S202 has all been selected (step S205). When the determination is that all of the evaluation target information has not been selected (step S205; N), the combination generating means 14 returns to step S203, selects one of the unselected new evaluation target information items and sends this selected new evaluation target information item to the attribute information linking means 12. By repeatedly executing steps S203 through S205, the attribute information linking means 12 generates linked attribute values in which the attribute values are linked in a prescribed order for all of the new evaluation target information items generated in step S202.

When the process has been conducted for all of the evaluation target information, (step S205; Y), the attribute information linking means 12 sends the generated linked attribute values to the hash generating means 13. The hash generating means 13 selects one of the received linked attribute values and converts this linked attribute value to a hash value (step S206).

The hash generating means 13 determines whether or not all of the linked attribute values received have been selected (step S207). When there are unselected linked attribute values (step S207; N), the hash generating means 13 returns to step S206, selects one of the unselected linked attribute values and generates a hash value. By repeatedly executing steps S206 and S207, the hash generating means 13 converts the linked attribute values to hash values for all of the linked attribute values corresponding to the new evaluation target information generated in step S202.

The hash generating means 13 sends to the evaluation target information processing means 15 the hash values that are converted linked attribute values, that is to say hash values corresponding to the new evaluation target information generated in step S202. Upon receiving the hash values, the evaluation target information processing means 15 selects one of the received hash values and sends an information search request including the selected hash value to the registered information management means 16. When hash values have been created for all of the linked attribute values (step S207; Y), the information searching means of the registered information management means 16, upon receiving the information search request, searches the hash table 19 and extracts entries using the hash value contained in the received information search request as a key (step S208). The information searching means 18 sends the registered information of the extracted entry to the evaluation target information management means 15.

The evaluation target information processing means 15 determines whether or not all of the hash values received from the attribute information linking means 12 have been selected (step S209). When all of the hash values have not been selected (step S209; N), the evaluation target information processing means 15 returns to step S208, selects one of the unselected hash values and sends an information search request including the selected hash value to the registered information management means 16. By repeatedly executing steps S208 and S209, the evaluation target information processing means 15 sends information search requests including hash values corresponding to the new evaluation target information generated in step S202 to the registered information management means 16 and accomplishes information searches. On the other hand, when all of the hash values have been searched (step S209; Y), this flow concludes.

In the present embodiment, the combination generating means 14 generates combinations picking out and combining 1 to M items of attribute information from evaluation target information having M items of attribute information. The attribute information linking means 12 generates linked attribute values in which the attribute values of the attribute information contained in each combination are linked, for each of the combinations generated by the combination generating means 14. The hash generating means 13 generates hash vales on the basis of the linked attribute values generated by the attribute information linking means 12. The information searching means 18 searches the hash table 19 and extracts registered information registered so as to correspond to a hash value that matches one of the hash values generated by the hash generating means 13.

In the present embodiment, combinations picking out and combining 1 to M items of attribute information contained in the evaluation target information are generated, and are converted to hash values after linking attribute values in the attribute information contained in that combination. By generating a hash value not just for the hash value itself of the evaluation target information but for a combination of attribute information contained in the evaluation target information, it is possible to obtained the same hash value as the hash value of that registered information for registered information containing a wild card indicating that attribute values may be arbitrary. By searching the hash table 19 using this kind of hash value, it is possible to extract not just registered information perfectly matching the evaluation target information but also registered information having fewer attribute information items that the number of attribute information items contained in the evaluation target information.

In the present embodiment, all hash values that become keys for registered information that should match the evaluation target information are created from the evaluation target information, and the hash table 19 is searched. By so doing, in an information search using the hash table 19, it is possible to search for registered information that matches evaluation target information not containing a wild card, even if the registered information contains the wild card that attribute values may be arbitrary.

Here, when the order of the attribute information contained in the registered information and the evaluation target information is not fixed, the hash values of the registered information and the evaluation target information differ depending on the order of the attribute information, even if the content of the included attribute information itself is the same content. For example, suppose that the registered information is {(age: 20s), (sex: M)}, and {(sex: M), (age: 20s)} is given as the evaluation target information. This registered information and evaluation target information have differing orders for the attribute information but the content of the information could be said to be the same. Accordingly, the registered information {(age: 20s), (sex: M)} matches the evaluation target information {(sex: M), (age: 20s)}. However, the hash value (Hash (20sM)) generated based on the registered information {(age: 20s), (sex: M)} is a different value from the hash value ((Hash (M20s)) generated based on the evaluation target information {(sex: M), (age: 20s)}. Consequently, even if the hash table is searched using the hash value of the evaluation target information {(sex: M), (age: 20s)}, the registered information {(age: 20s), (sex: M)} that should be found is not found.

In the present embodiment, the above-described problem is resolved by the attribute information contained in the registered information and the evaluation target information being lined up in a prescribed order by the attribute information linking means 12. The hash generating means 13 generates hash values on the basis of attribute values of attribute information linked in the prescribed order. By so doing, hash values generated along with registered information in the hash table 19 and hash values generated from evaluation target information during information searches can be the same value if the contents of the attribute information is the same, without dependence on the ordering thereof. In the above example, the hash value registered in the hash table 19 in correspondence to the registered information {(age: 20s), (sex: M)} and the hash value generated from the evaluation target information {(sex: M), (age: 20s)} when searching information can have the same value. Accordingly, in the present embodiment, even if the ordering of the attribute information in the registered information and in the evaluation target information do not match, information searches using the hash table are possible.

A second embodiment of the present invention will now be described. The composition of the information search system of the second embodiment is the same as the composition of the information search system of the first embodiment shown in FIG. 1. In this embodiment, attribute selection information specifying attribute information to be used when generating combinations in the combination generating means 14 is introduced in the attribute information contained in the evaluation target information. The evaluation target information processing means 15 receives evaluation target information and attribute selection information. The attribute selection information is information that is input as needed. The evaluation target information processing means 15 sends the evaluation target information and the attribute selection information to the combination generating means 14.

When attribute selection information is not input, the combination generating means 14 generates combinations in which 1 to M attribute information items from the evaluation target information are extracted and combined, the same as in the first embodiment. When attribute selection information is input, the combination generating means 14 generates combinations including attribute information stipulated by the attribute selection information out of the combinations in which 1 to M attribute information items from the evaluation target information are extracted and combined. In other words, the combination generating means 14 generates combinations in which 1 to M items are selected and combined including attribute information stipulated by the attribute selection information, from the evaluation target information containing M attribute information items.

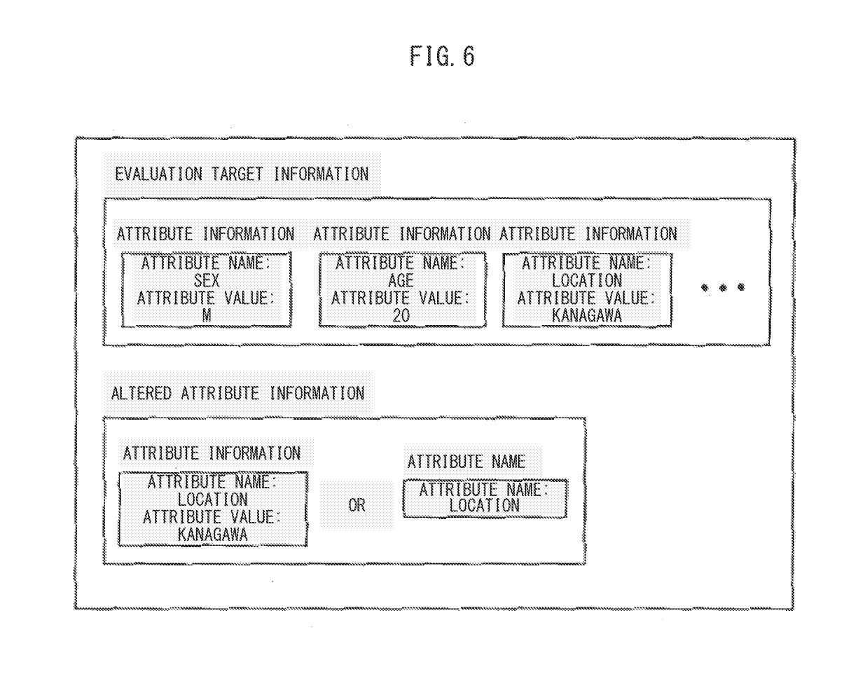

FIG. 6 shows the information received by the evaluation target information processing means 15. Here, the attribute selection information is taken as altered attribute information indicating attribute information that was altered from the evaluation target information used in the prior information search. In the example in FIG. 6, the altered attribute information is the attribute name: location. That is to say, when the evaluation target information shown in FIG. 6 and the prior evaluation target information are compared, the attribute information that differs is the part (location: Kanagawa). The other parts (attribute name: sex, age) have the same attribute values as the attribute information in the prior evaluation target information. The altered attribute information may be the altered part of attribute information used in generating combinations (attribute name and attribute value), or may be the attribute name of the attribute information used in generating combinations.

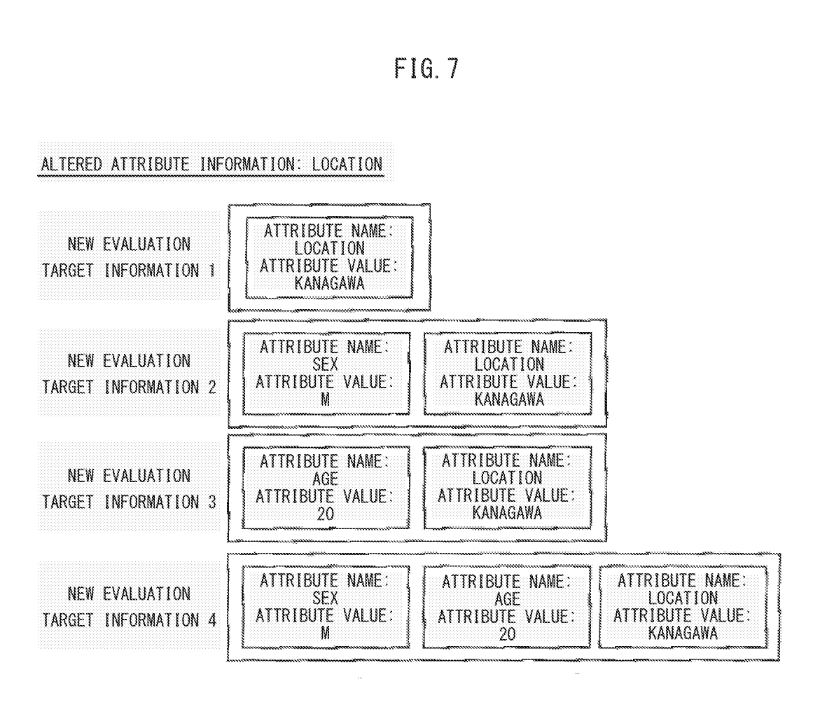

FIG. 7 shows a concrete example of combinations generated by the combination generating means 14. Suppose that the information shown in FIG. 6 is given as the evaluation target information and the altered attribute information. The combination generating means 14 generates combinations containing “attribute name: location” indicating the altered attribute information, from the evaluation target information shown in FIG. 6. These are the new evaluation target information. In FIG. 5, as a result of making all combinations new evaluation target information, the number of new evaluation target information items (number of combinations) is 7. In contrast, in FIG. 7 because combinations containing the attribute information of attribute name indicating the altered attribute information, out of all combinations, are set as new evaluation target information, the number of new evaluation target information items is 4.

The operation sequence will be explained. The operation sequence of information registration is the same as the sequence in the first embodiment shown in FIG. 3. In addition, the operation sequence of information evaluation is the same as the sequence in the first embodiment shown in FIG. 4. However, when attribute selection information is input along with evaluation target information into the evaluation target information processing means 15, the operation of combining attribute information generated by generation of combinations accomplished in step S202 differs from the first embodiment. Those differences are explained below.

Upon receiving the evaluation target information and the attribute selection information (altered attribute information) in step S201, the evaluation target information processing means 15 sends the evaluation target information and the altered attribute information to the combination generating means 14. Upon receiving the evaluation target information and the altered attribute information from the evaluation target information processing means 15, the combination generating means 14 extracts attribute information from the evaluation target information. Taking the number of attribute information items contained in the evaluation target information to be M, the combination generating means 14 generates combinations selecting 1 to M attribute information items containing the attribute information indicated by the altered attribute information from the M attribute information items.

For example, when the evaluation target information {(age: 20), (sex: M), (location: Kanagawa)} shown in FIG. 6 and the altered attribute information {location} are received, the combination generating means 14 generates from the three attribute information items contained in the evaluation target information the combination {location: Kanagawa} of one item containing the attribute information of location name: location, the combinations {(age: 20), (location: Kanagawa)} and {(sex: M), (location: Kanagawa)} of two items containing the attribute information attribute name: location, and the combination {(age: 20), (sex: M), (location: Kanagawa)} of three items containing the attribute information attribute name: location (FIG. 7). The combination generating means 14 sets these combinations as new evaluation target information and passes such to the attribute information linking means 12.

When altered attribute information is input, the attribute information linking means 12 generates linked attribute values whose attribute values are linked for combinations including attribute information indicating altered attribute information, from the combinations of attribute information contained in the evaluation target information created in step S202. The hash generating means 13 generates hash values on the basis of the linked attribute values generated by the attribute information linking means 12 in step S206. Because the attribute information linking means 12 generates linked attribute values for combinations including attribute information indicating altered attribute information, out of the combinations of attribute information contained in the evaluation target information, the hash generating means 13 generates hash values corresponding to combinations of attribute information indicating altered attribute information, out of the combinations of attribute information contained in the evaluation target information. The information searching means 18 searches in the hash table 19 using hash values generated by the hash generating means 13 in step S208.

In the present embodiment, the combination generating means 14 generates combinations containing attribute information stipulated by the attribute stipulating information, out of the combinations of attribute information contained in the evaluation target information. The attribute information linking means 12 arranges and links in a prescribed order the attribute information contained in the combinations generated by the combination generating means 14. The hash generating means 13 generates hash values from the linked attribute values linked by the attribute information linking means 12. The evaluation target information processing means 15 sends an information search request containing the hash values generated by the hash generating means 13 to the registered information management means 16. The information searching means 18 searches the hash table 19, extracts entries using hash values that match the hash values contained in the information search request as keys, and sends the result to the evaluation target information processing means 15. In the present embodiment, the number of combinations generated by the combination generating means 14 is reduced compared to the first embodiment, and the number of hash values generated and the search frequency of the hash table are reduced compared to the first embodiment, so it is possible to reduce processing by the system as a whole.

For example, consider a case where information searching is accomplished with certain evaluation target information 1 and then later information searching is accomplished with separate evaluation target information 2. The information search system extracts registered information that matches combinations of attribute information contained in the evaluation target information with the sequence explained in the first embodiment, for the evaluation target information 1. For the information search for the evaluation target information 2 conducted after this, altered attribute information (attribute stipulating information) indicating attribute information that differs between the evaluation target information 1 and the evaluation target information 2 is input along with the evaluation target information 2 into the evaluation target information processing means 15. In the information search for the evaluation target information 2, the information search system accomplishes the information search using the hash values of the combinations including the altered attribute information.

Here, combinations of attribute information not including attribute information indicated by the altered attribute information are not included in the combinations generated by the information search for the evaluation target information 2. However, attribute information other than the attribute information indicated by the altered attribute information, out of the attribute information contained in the evaluation target information 2, is contained in the evaluation target information 1, so combinations of attribute information not containing the attribute information indicated by the altered attribute information have already been created when the information search was conducted for the evaluation target information 1. Accordingly, the fact that registered information matching combinations of attribute information common between the evaluation target information 1 and the evaluation target information 2 was extracted at the time of the information search for the evaluation target information 1 is assured. Consequently, no problems arise if this is not extracted by the information search for the evaluation target information 2.

An explanation will be given using a concrete example. Suppose that entries containing the registered information of {(age: 20s), (sex: M)} and {(age: 20s), (sex: M), (location: Kanagawa)} are registered in the hash table 19. When the evaluation target information {(age: 20s), (sex: M), (location: Tokyo)} is input, the combination generating means 14 generates the seven combinations shown in FIG. 5. The information search system converts the seven combinations shown in FIG. 5 (new evaluation target information 1 to 7) into hash values and accomplishes information searches, thereby extracting the registered information {(age: 20s), (sex: M)}.

Following the information search for the above-described evaluation target information 1, an information search is accomplished for the evaluation target information 2. At this time, altered attribute information {(location: Kanagawa)} indicating the locations altered from the evaluation target information 1 is input into the evaluation target information processing means 15 in addition to the evaluation target information 2 {(age: 20s), (sex: M), (location: Kanagawa)} (FIG. 6). The combination generating means 14 generates combinations containing (location: Kanagawa) out of the combinations of attribute information contained in the evaluation target information 2 (FIG. 7). By accomplishing an information search after converting the four combinations (new evaluation target information 1 to 4) shown in FIG. 7 into hash values, the information search system extracts {(age: 20s), (sex: M), (location: Kanagawa)}. The information search system does not extract {(age: 20s), (sex: M)} with this information search for the evaluation target information 2.

With the first embodiment, the combination generating means 14 generates:

$${\sum }_{i = 1}^{M} {}_{M}^{}{C}{}_{i}^{} = {2}^{M} - 1 \qquad [ Formula 1 ]$$

combinations, where M is the number of attribute information items contained in the evaluation target information. In the first embodiment, hash values are created for these combinations and a search is made of the hash table 19. With this embodiment, using the attribute stipulating information the combinations generated by the combination generating means 14 are limited to combinations containing attribute information indicated by the attribute stipulating information, out of the combinations of attribute information contained in the evaluation target information. By limiting the combinations generated by the combination generating means 14 to combinations including attribute information indicated by the attribute stipulating information, matches are not made in information searches for evaluation target information already conducted, but registered information that matches results of information searches on this evaluation target information can be extracted. The present embodiment can reduce the number of searches of the hash table and generation of hash values compared to the first embodiment, which generates all combinations, so processing volume for the system as a whole can be reduced.

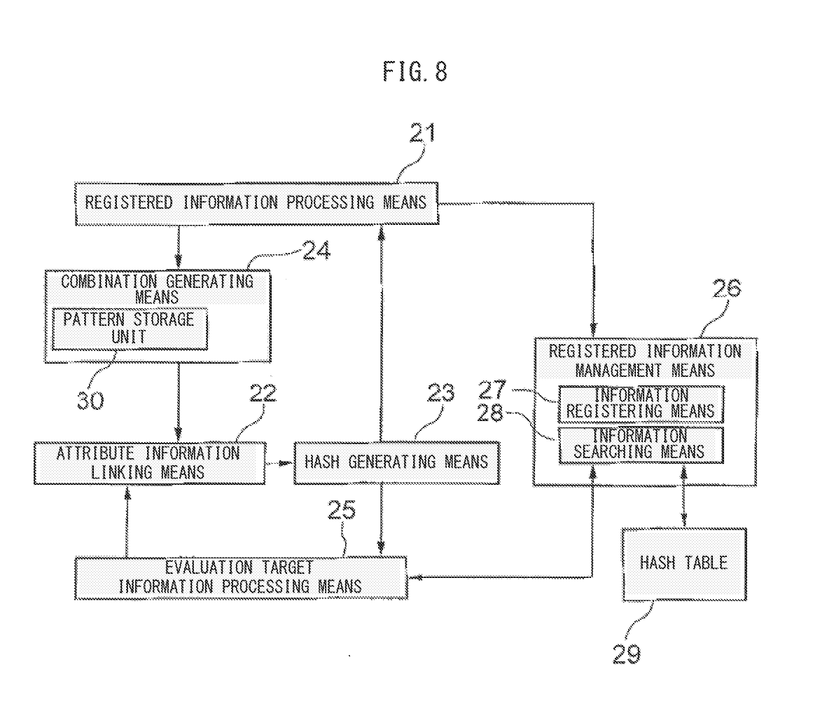

A third embodiment of the present invention will next be explained. FIG. 8 shows an information search system according to the third embodiment of the present invention. The information search system of the present embodiment has a registered information processing means 21, a combination generating means 24, a hash generating means 23, an attribute information linking means 22, an evaluation target information processing means 25 and a registered information management means 26. The registered information management means 26 has an information registering means 27 and an information searching means 28. The registered information processing means 21, combination processing means 24, hash generating means 23, attribute information linking means 22 and information registering means 27 correspond to the information management device.

In the first embodiment, combinations of evaluation target information are generated using the combination generating means 14 (FIG. 1) and the linked attribute values thereof are converted to hash values. In contrast, in the present embodiment combinations of registered information are generated using the combination generating means 24 and the linked attribute values thereof are converted to hash values. This is the primary point of difference between the first embodiment and the third embodiment.

The registered information processing means 21 receives registered information containing one or more attribute information items. The evaluation target information processing means receives evaluation target information containing one or more attribute information items. The registered information and the evaluation target information are the same as that shown in FIG. 2. The registered information management means 26 accomplishes registration of information and searching of registered information.

The combination generating means 24 has a pattern storage unit 30 for recording attribute information handled by the information search system. In the pattern storage unit 30, attribute values of attribute information handled as registered information are recorded in advance. The combination generating means 24 receives registered information from the registered information processing means 21. The combination generating means 24 designates the attribute information of which attribute names are not included in the received registered information, out of the attribute information input. The combination generating means 24 generates a supplemental pattern composed of combinations of attribute values of attribute information not included in the registered information, with reference to the pattern storage unit 30. The combination generating means 24 adds registered information to the supplemental pattern generated, and sets this as the supplemental attribute information. The combination generating means 24 sets the generated supplemental attribute information as new registered information.

The attribute information linking means 22 links the attribute values of the attribute information contained in the registered information and the evaluation target information. At this time, the attribute information linking means 22 generates linked attribute values after arranging the attribute information in a prescribed order. The attribute information linking means 22 accomplishes ordering and attribute value linking of the registered information input and the new registered information generated by the combination generating means 24, for the registered information. In other words, the attribute information linking means 22 generates linked attribute values linking attribute values of attribute information contained in the registered information input into the registered information processing means 21 and the supplemental attribute information that adds the supplemental pattern to the registered information. The order in which the attribute information in the attribute information linking means 22 is lined up may be the same order in which the attribute information in the attribute information linking means 12 in the first embodiment is lined up. The hash generating means 23 performs a hash conversion converting the linked attribute information generated by the attribute information linking means 22 into hash values. For the hash conversion, for example a general hash function as represented by MD5 of SHA can be used.

The registered information management means 26 accomplishes information management using the hash table 29. The information recording means 27 of the registered information management means 26 receives an information registration request from the registered information processing means 21. The information registration means 27 records the registered information in the hash table 29 so as to correspond to the hash values converted by the hash generating means 23. More concretely, the information registering means 27 creates entries that are values of the registered information in the hash table 29 using as keys each hash corresponding to the registered information input and the new registered information generated by the combination generating means 24, and records the registered information in the hash table 29.

The information searching means 28 receives information search requests from the evaluation target information processing means 25. Upon receiving an information search request, the information searching means 28 searches the hash table 29 and extracts registered information registered so as to correspond to the hash value that matches the hash value of the evaluation target information generated by the hash generating means 23.

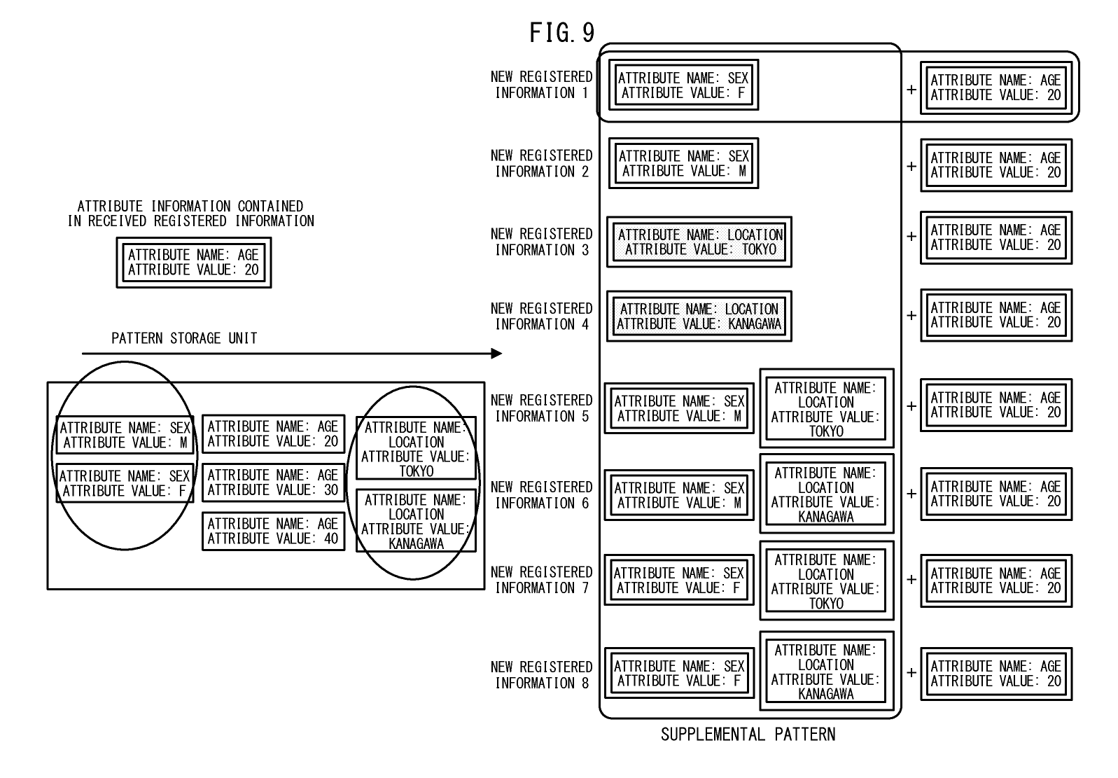

FIG. 9 shows an example of data in the pattern storage unit 30 and an example of the data of the supplemental pattern generated by the combination generating means 24. Here, consider the three attribute information items of sex, age and location as attribute values handled by the system. The pattern storage unit 30 stores for the attribute name: sex the attribute value: M and the attribute value: F. In addition, the pattern storage unit 30 stores for the attribute name: age the attribute value: 20s, the attribute value: 30s and the attribute value: 40s. The pattern storage unit 30 stores for the attribute name: location the attribute value: Tokyo and the attribute value: Kanagawa.

Suppose that the registered information received by the registered information processing means 21 is {(age: 20s)}. The combination generating means 24 compares the attribute names of the attribute information contained in the registered information with the attribute names stored by the pattern storage unit 30. The combination generating means stipulates attribute names that do not match the attribute names of attribute information contained in the registered information, out of the attribute names of the attribute information stored by the pattern storage unit 30. In other words, the combination generating means 24 stipulates attribute names of attribute information lacking in the registered information received, out of all the attribute information contained in the registered information. In the above-described case, the combination generating means 24 stipulates the attribute information of attribute name: sex and attribute name: location as missing attribute information.

The combination generating means 24 generates combinations of the above-described stipulated lacking attribute information (supplemental pattern) with reference to the pattern storage unit 30. In the case in FIG. 9, the missing attribute information is the two items attribute name: sex and attribute name: location, and each of these has two attribute values, so when combinations are created by selecting one attribute value for each attribute name, a total of 8 combinations are possible. The combination generating means 24 sets the supplement attribute information, which is the registered information to which attribute information contained in the supplemental pattern has been added, as the new registered information (new registered information 1 to 8).

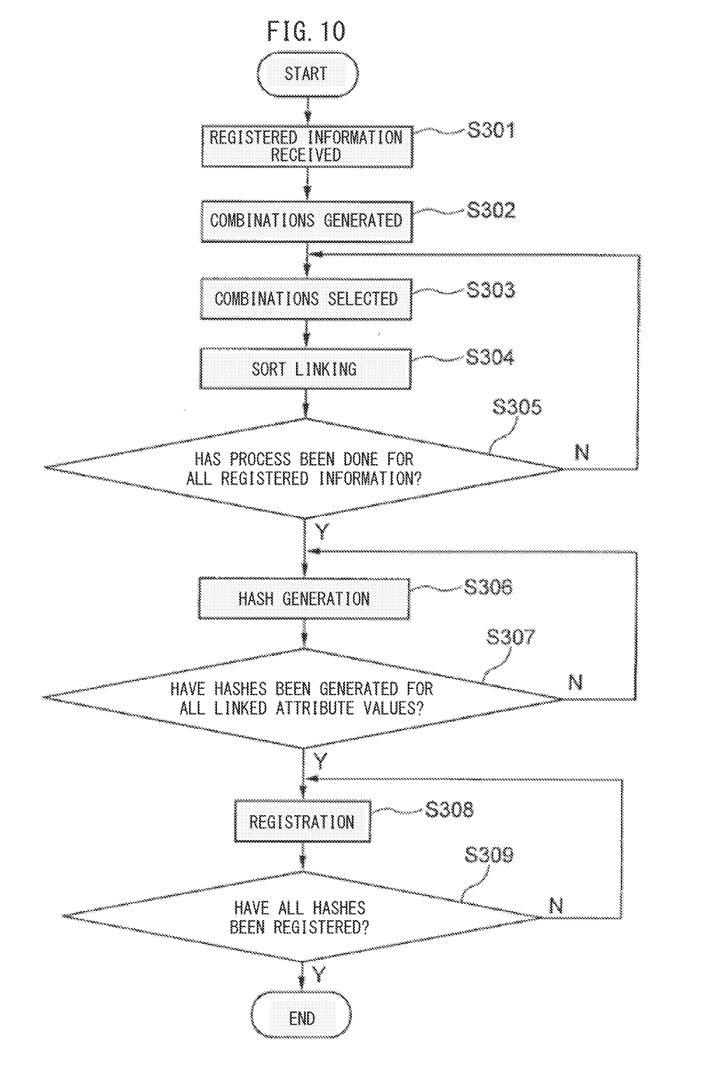

FIG. 10 shows the sequence of operations of information registration. This is explained below with reference to this drawing.

The registered information processing means 21 receives registered information containing one or more attribute information items (step S301). The registered information processing means 21 passes the received registered information to the combination generating means 24. When the types of attribute information input are the N types of age, sex, location, . . . , the registered information may include all N types of attribute information or may include only the three types of attribute information of age, sex and location. The attribute information not included is handled as a wild card that may take on any value.

Upon receiving the registered information from the registered information processing means 21, the combination generating means 24 generates the supplemental pattern with reference to the pattern storage unit 30 and combines the supplemental pattern with the registered information (step S302). The combination generating means 24 in step S302 first extracts the attribute information from the registered information and compares the attribute names of the extracted attribute information with the attribute names of attribute information stored in the pattern storage unit 30. Next, the combination generating means 24 stipulates attribute names not contained in the registered information, out of the attribute names of the attribute information stored in the pattern storage unit 30. The combination generating means 24 selects one attribute information item of attribute names not contained in the registered information for each attribute name and generates a supplemental pattern combining this attribute information. The combination generating means 24 generates supplemental attribute information in which the supplemental pattern has been added to the attribute information of the registered information as the new registered information.

The combination generating means 24 selects one of the registered information items received from the registered information processing means 21 (the original registered information) and from the new registered information generated in step S302 and sends the results to the attribute information linking means (step S303).

The attribute information linking means 22 extracts attribute information from the registered information received from the combination generating means 24, and generates linked attribute values in which the attribute information is lined up in a prescribed order and linked (step S304).

The combination generating means 24 determines whether or not all of the registered information has been selected (step S305). When unselected registered information remains (step S305; N), the combination generating means 24 returns to step S303, selects one of the unselected registered information items and sends this to the attribute information linking means 22. By repeatedly executing steps S303 to S305, the attribute information linking means generates linked attribute values in which the attribute values are linked in a prescribed order, for the original registered information and the new registered information generated in step S302.

The attribute information linking means 22 sends the linked attribute information generated to the hash generating means 23. When the process has been accomplished for all registered information (step S305; Yes), the hash generating means 23 selects one of the linked attribute values received and converts the linked attribute value into a hash value (step S306).

The hash generating means 23 determines whether or not all of the linked attribute values received have been selected (step S307), and when there are unselected linked attribute values (step S307; N), returns to step S306, selects one of the unselected linked attribute values and generates a hash value. By repeatedly executing steps S306 and S307, the hash generating means 23 converts linked attribute values corresponding to the original registered information and the new registered information generated in step S302 into hash values.

The attribute information linking means 22 sends the hash values of converted linked attribute values, in other words the hash values corresponding to the original registered information and the new registered information generated in step S302, to the registered information processing means 21. Upon receiving the hash values, the registered information processing means 21 selects one of the received hash values, and sends an information registration request containing the selected hash value and the registration information to the registered information management means 26. When hash values have been created for all linked attribute values (step S307; Y), the information registering means 27 of the registered information management means 26 creates an entry whose value is the registered information in the hash table 29 with the hash value contained in the information registration request as the key, and manages the registration information using the hash value (step S308). At this time, the information registering means 27 determines whether or not an entry having the same hash value as a key already exists, and when such exists, accomplishes list management as an entry having the same hash key.

The registered information processing means 21 determines whether or not the hash values received from the attribute information linking means 22 have all been selected (step S309). When all of the hash values have not been selected (step S309; N), the registered information processing means returns to step S308, selects one of the unselected hash values and sends an information registration request containing the selected hash value to the registered information management means 26. By repeatedly executing steps S308 and S309, the information registering means 27 of the registered information management means 26 records the hash values corresponding to the original registered information and the hash values corresponding to the new registered information generated in step S302 in the hash table 29. By accomplishing information registration in the sequence shown in FIG. 10, it is possible accomplish management with the hash table so as to link the registered information, for hash values of patterns of all evaluation target information that match the registered information. On the other hand, when all of the hash values have been registered (step S309; Y), this flow concludes.

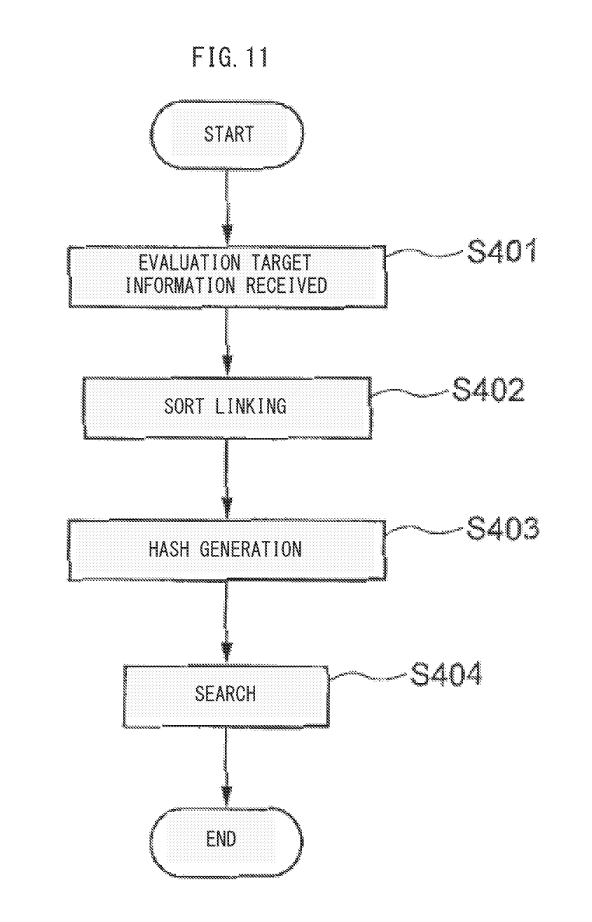

FIG. 11 shows the operation sequence of information evaluation. This is described below with reference to this figure.

The evaluation target information processing means 25 receives evaluation target information containing one or more attribute information items (step S401). The evaluation target information processing means 25 sends the evaluation target information to the attribute information linking means 22.

The attribute information linking means 22 extracts attribute information from the evaluation target information received from the evaluation target information processing means 25, arranges the attribute information in a prescribed order and generates linked attribute values in which the attribute values are linked (step S402). The attribute information linking means 22 sends the linked attribute values generated to the hash generating means 23.

The hash generating means 23 receives the linked attribute values from the attribute information linking means 22. The hash generating means 23 does a hash conversion on the linked attribute values of the evaluation target information received from the attribute information linking means 22 (step S403). The hash generating means 23 sends the converted hash values to the evaluation target information processing means 25. Upon receiving the hash values corresponding to the evaluation target information, the evaluation target information processing means 25 sends an information search request including the received hash values to the registered information management means 26.

Upon receiving the information search request from the evaluation target information processing means 25, the registered information management means 26 obtains entries from the hash table 29 using the hash values contained in the information search request as the key (step S404). The registered information management means 26 passes the registered information of the acquired entries to the evaluation target information processing means 25. In the hash table 29, not only are hash values generated from the registered information itself at the time of information registration recorded, but so are hash values generated from supplemental attribute information in which the supplemental pattern was added to the registered information. Accordingly, by accomplishing the information search in the sequence shown in FIG. 11, it is possible to extract registered information that matches that evaluation target information from the evaluation target information, even when the registered information contains a wild card

In the present embodiment, the combination generating means 24 generates a supplemental pattern composed of combinations of attribute information not contained in the registered information input to the registered information processing means 21, out of the attribute information obtained as registration information, with reference to the pattern storage unit 30, and sets the supplemental attribute information in which the supplemental pattern has been added to the registered information as the new registered information. The attribute information linking means 22 generates linked attribute values in which attribute values are linked, for the registered information and the supplemental attribute information in which the supplemental pattern has been added to the registered information. The hash generating means 23 accomplishes hash conversion on the linked attribute values generated by the attribute information linking means 22. The information registering means 27 registers the registered information in the hash table 29 so as to correspond to the hash values converted by the hash generating means 23.

The new registered information generated by the combination generating means 24 in which the registered information has been added to the supplemental pattern matches the pattern of the evaluation target information that should be matched when doing an information search. The information registration means 27 records the hash values corresponding to the registered information and the hash values corresponding to the new registered information generated by the combination generating means 24 in the hash table 29 so as to correspond to the registered information. By accomplishing this kind of information registration, it is possible to extract not just registration information completely matching the evaluation target information but to extract registration information containing wild cards, using the hash values of the evaluation target information when doing an information search. The results obtained by the attribute information linking means 22 linking the attribute values of the registered information and the evaluation target information in the prescribed order are the same as in the first embodiment.

When the third embodiment is compared to the first and second embodiments, in the third embodiment it is necessary to input the attribute values of the attribute information that is handled as registered information into the pattern storage unit 30 in advance. However, in the third embodiment, unlike the first and second embodiments, it is not necessary to generate combinations of the evaluation target information during information searches, so processing time when undertaking information evaluation can be shortened compared to the first and second embodiments. From this, it could be said that the present embodiment is effective in a system that accomplishes a streaming process in which evaluation target information is processed in real time.

The present invention was described above with reference to the preferred embodiments thereof, but the information search system, information management device, information search method, information management method and recording medium of the present invention are not limited to the above-described embodiments, and various modifications and alterations to the composition of the above-described embodiments are also included within the scope of the present invention.

Finally, the minimum composition of the present invention will be described. The information search system of the present invention has in its minimum composition an evaluation target information processing means, a combination generating means, an attribute information linking means, a hash generating means and an information searching means. The evaluation target information processing means inputs evaluation target information having M (where M is 1 or more and an integer) items of attribute information containing attribute values. The combination generating means generates combinations picking out and combining 1 to M attribute information items from the evaluation target information. The attribute information linking means generates linked attribute values linking the attribute values of the attribute information contained in each combination, for each of the combinations. The hash conversion means converts the linked attribute values into hash values. The information searching means searches the hash table where registered information having one or more of the attribute information items is stored so as to correspond to the hash values that converted the linked attribute values linking attribute values of the attribute information contained in the registered information, and extracts registered information recorded so as to correspond to the hash values matching any of the hash values converted by the hash generating means.

The minimum composition of the information search method of the present invention is a step for generating combinations by picking out and combining 1 to M attribute information items from evaluation target information having M (where M is 1 or more and an integer) items of attribute information containing attribute values, and generating linked attribute values linking the attribute values of the attribute information contained in each combination, for each of the generated combinations; a step for converting the linked attribute values generated in the attribute information linking step into hash values; and a step for searching the hash table where registered information having one or more of the attribute information items is stored so as to correspond to the hash values that converted the linked attribute values linking attribute values of the attribute information contained in the registered information, and extracting registered information recorded so as to correspond to the hash values matching any of the hash values converted in the step for converting hash values.

The minimum composition of the computer-readable recording medium on which a program is recorded of the present invention is a composition that causes a computer to execute a process for generating combinations by picking out and combining 1 to M attribute information items from evaluation target information having M (where M is 1 or more and an integer) items of attribute information containing attribute values, and generating linked attribute values linking the attribute values of the attribute information contained in each combination, for each of the generated combinations; a process for converting the linked attribute values into hash values; and a process for searching the hash table where registered information having one or more of the attribute information items is stored so as to correspond to the hash values that converted the linked attribute values linking attribute values of the attribute information contained in the registered information, and extracting registered information recorded so as to correspond to the hash values matching any of the hash values converted in the hash converting process.

With the information search system, information search method, and computer-readable recording medium on which a program is recorded according to the present invention, combinations of attribute information contained in evaluation target information are generated, and the attribute information contained in the generated combinations are linked and converted to hash values. Following this, a hash table is searched using the hash values corresponding to the combinations and registered information is extracted. The combinations generated by picking out attribute information from the evaluation target information agree with the registered information that should match that evaluation target information. Accordingly, by searching the hash table using hash values corresponding to the generated combinations, it is possible to extract not just registered information that perfectly matches the evaluation target information but also registered information containing fewer attribute information items than the evaluation target information, that is to say containing wild cards.

The information search system of the present invention has as a minimum composition a registered information processing means, a combination generating means, an attribute information linking means, a hash generating means, an information registering means, an evaluation target information processing means and an information searching means. The registered information processing means inputs registered information having one or more attribute information items containing attribute values. The combination generating means generates a supplemental pattern composed of combinations of attribute values of attribute information not contained in the registered information, out of the attribute information handled as registered information, with reference to a pattern storage unit that stores attribute values of attribute information handled as registered information. The combination generating means generates supplemental attribute information in which a supplemental pattern has been added to the registered information. The attribute information linking means generates linked attribute values linking attribute values of attribute information respectively contained in the registered information and the supplemental attribute information. The hash generating means converts the linked attribute values to hash values. The information registering means registers the registered information in a hash table so as to correspond to the hash values converted by the hash generating means. The evaluation target information processing means inputs evaluation target information containing one or more attribute information item and generates an information search request containing hash values that are linked attribute values linking attribute values contained in the input evaluation target information using the attribute information linking means, converted using the hash generating means. The information searching means searches the hash table and extracts registered information registered so as to correspond to hash values that match the hash values contained in the information search request.

The minimum composition of the information search method of the present invention is a composition having a step for inputting registered information having one or more attribute information items containing attribute values, and generating a supplemental pattern composed of combinations of attribute values of attribute information not contained in the registered information, out of the attribute information handled as registered information, with reference to a pattern storage unit that stores attribute values of attribute information handled as registered information; a step for generating linked attribute values linking attribute values of attribute information respectively contained in the registered information and the supplemental attribute information in which the supplemental pattern has been added to the registered information; a step for converting the linked attribute values to hash values; a step for registering the registered information in a hash table so as to correspond to the hash values converted by the step for converting to hash values; a step for inputting evaluation target information containing one or more attribute information items and converting the linked attribute values linking attribute values contained in the input evaluation target information into hash values; and a step for searching the hash table and extracting registered information registered so as to correspond to hash values that match the hash values that are converted evaluation target information.

The minimum composition of the computer-readable recording medium on which a program is recorded according to the present invention is a composition in which a computer is caused to execute a process for inputting registered information having one or more attribute information items containing attribute values, and generating a supplemental pattern composed of combinations of attribute values of attribute information not contained in the registered information, out of the attribute information handled as registered information, with reference to a pattern storage unit that stores attribute values of attribute information handled as registered information; a process for generating linked attribute values linking attribute values of attribute information respectively contained in the registered information and the supplemental attribute information in which the supplemental pattern has been added to the registered information; a process for converting the linked attribute values to hash values; a process for registering the registered information in a hash table so as to correspond to the hash values converted by the process for converting to hash values; a process for inputting evaluation target information containing one or more attribute information items and converting the linked attribute values linking attribute values contained in the input evaluation target information into hash values; and a process for searching the hash table and extracting registered information registered so as to correspond to hash values that match the hash values that are converted evaluation target information.

With the information search system, information search method and computer-readable recording medium on which a program is recorded according to the present invention, a supplemental pattern composed from combinations of attribute values of attribute information not contained in the registered information is generated at the time of information registration using a pattern storage unit. When registering information in the hash table, not only are hash values corresponding to the registered information registered, but so are hash values corresponding to the supplemental attribute information in which the supplemental pattern has been added to the registered information. The supplemental attribute information in which the supplemental pattern has been added to the registered information agrees with the pattern of the evaluation target information that should match the registered information. Accordingly, by searching the hash table using the hash values corresponding to the evaluation target information, it is possible to extract not just registered information perfectly matching the evaluation target information but also registered information containing fewer attribute information items than the evaluation target information, that is to say containing wild cards.

The information management device of the present invention in its minimum composition has a registered information processing means, a combination generating means, an attribute information linking means, a hash generating means and an information registering means. The registered information processing means inputs registered information having one or more attribute information items containing attribute values. The combination generating means generates a supplemental pattern composed of combinations of attribute values of attribute information not contained in the registered information, out of the attribute information handled as registered information, with reference to a pattern storage unit that stores attribute values of attribute information handled as registered information. The combination generating means generates supplemental attribute information in which the supplemental pattern has been added to the registered information. The attribute information linking means generates linked attribute values linking attribute values of attribute information respectively contained in the registered information and the supplemental attribute information. The hash generating means converts the linked attribute values to hash values. The information registering means registers the registered information in a hash table so as to correspond to the hash values converted by the hash generating means.

The minimum composition of the information management method of the present invention is a composition having a step for inputting registered information having one or more attribute information items containing attribute values, and generating a supplemental pattern composed of combinations of attribute values of attribute information not contained in the registered information, out of the attribute information handled as registered information, with reference to a pattern storage unit that stores attribute values of attribute information handled as registered information; a step for generating linked attribute values linking attribute values of attribute information respectively contained in the registered information and the supplemental attribute information; a step for converting the linked attribute values to hash values; and a step for registering the registered information in a hash table so as to correspond to the hash values converted in the step for converting to hash values.

The minimum composition of the computer-readable recording medium on which a program is recorded according to the present invention is a composition in which a computer is caused to execute a process for inputting registered information having one or more attribute information items containing attribute values, and generating a supplemental pattern composed of combinations of attribute values of attribute information not contained in the registered information, out of the attribute information handled as registered information, with reference to a pattern storage unit that stores attribute values of attribute information handled as registered information; a process for generating linked attribute values linking attribute values of attribute information respectively contained in the registered information and the supplemental attribute information; a process for converting the linked attribute values to hash values; and a process for registering the registered information in a hash table so as to correspond to the hash values converted in the process for converting to hash values.

With the information management device, information management method and computer-readable recording medium on which a program is recorded according to the present invention, a supplemental pattern composed from combinations of attribute values of attribute information not contained in the registered information is generated at the time of information registration using a pattern storage unit. When registering information in the hash table, not only are hash values corresponding to the registered information registered, but so are hash values corresponding to the supplemental attribute information in which the supplemental pattern has been added to the registered information. The supplemental attribute information in which the supplemental pattern has been added to the registered information agrees with the pattern of the evaluation target information that should match the registered information. Accordingly, by accomplishing this kind of information registration, when searching the hash table using the hash values corresponding to the evaluation target information in information searches, it is possible to extract not just registered information perfectly matching the evaluation target information but also registered information containing fewer attribute information items than the evaluation target information, that is to say containing wild cards.

This application claims the benefit of Japanese Patent Application 2009-160642, the entire disclosure of which is incorporated by reference herein.

### INDUSTRIAL APPLICABILITY

The present invention can be applied to a system for executing a grouping process, a streaming process or a specified process at high speed on input evaluation target information such as rule matching. In addition, the present invention can also be applied to applications for similar searches when searching for information that does not match perfectly but contains much information that matches.

### EXPLANATION OF SYMBOLS

11, 21: registered information processing means
12, 22: attribute information linking means
13, 23: hash generating means
14, 24: combination generating means
15, 25: evaluation target information processing means
16, 26: registered information management means
17, 27: information registering means
18, 28: information searching means
19, 29: hash table
30: pattern storage unit

1. An information search system, comprising:
an evaluation target information processing means for inputting evaluation target information having M (where M is 1 or more and an integer) items of attribute information containing attribute values;
a combination generating means for generating combinations made by picking out and combining 1 to M attribute information items from the evaluation target information input into the evaluation target information processing means;
an attribute information linking means for generating linked attribute values linking attribute values of the attribute information contained in each combination, for the combinations generated by the combination generating means;
a hash generating means for converting linked attribute values generated by the attribute information linking means into hash values; and,
an information searching means for searching a hash table in which registered information having one or more attribute information item is stored so as to correspond to hash values converted from the linked attribute values linking the attribute values of attribute information contained in the registered information, and extracting registered information registered so as to correspond to hash values that match any of the hash values converted by the hash generating means.

2. The information search system according to claim 1, wherein attribute selection information stipulating attribute information used when generating combinations, out of the attribute information contained in the evaluation target information, is input into the combination generating means, which generates combinations containing attribute information stipulated by the attribute selection information, out of the combinations made by picking out and combining 1 to M items of attribute information from the evaluation target information.

3. The information search system according to claim 2, wherein the attribute selection information is altered attribute information indicating attribute information that was changed from the evaluation target information used in a prior information search.

4. The information search system according to claim 3, further comprising:
a registered information processing means into which registered information is input and which generates an information registration request containing the input registered information and hash values generated by using the hash generating means to convert linked attribute values linking attribute values contained in the input registered information, using the attribute information linking means; and
an information registering means for receiving the information registration request and registering the registered information contained in the information registration request in the hash table so as to correspond to the hash values contained in the information registration request.

5. The information search system according to claim 4, wherein the attribute information linking means links the attribute values after arranging the attribute information in a prescribed order.

6. The information search system according to claim 5, wherein the attribute information further contains an attribute name, and the attribute information linking means arranges the attribute information on the basis of the attribute name.

7. An information search system, comprising:
a registered information processing means for inputting registered information having one or more attribute information item containing an attribute value;
a combination generating means for referencing a pattern storage unit that stores attribute values of attribute information handled as registered information, generating a supplemental pattern composed of combinations of attribute values of attribute information not contained in the registered information input into the registered information processing means, out of the attribute information handled as registered information, and generating supplemental attribute information in which the supplemental pattern is added to the registered information;
an attribute information linking means for generating linked attribute values linking attribute values of attribute information contained respectively in the registered information and the supplemental attribute information;
a hash generating means for converting linked attribute values generated by the attribute information linking means into hash values;
an information registering means for registering the registered information in a hash table so as to correspond to hash values converted by the hash generating means;
an evaluation target information processing means for inputting evaluation target information containing one or more attribute information item and for generating an information search request containing hash values that are linked attribute values linking attribute values contained in the input evaluation target information using the attribute information linking means, converted using the hash generating means; and
an information searching means for searching the hash table and extracting registered information registered so as to correspond to hash values matching hash values contained in the information search request.

8. The information search system according to claim 7, wherein the attribute information linking means links the attribute values after arranging the attribute information in a prescribed order.

9. An information management device, comprising:
a registered information processing means for inputting registered information having one or more attribute information item containing an attribute value;
a combination generating means for referencing a pattern storage unit that stores attribute values of attribute information handled as registered information, generating a supplemental pattern composed of combinations of attribute values of attribute information not contained in the registered information input into the registered information processing means, out of the attribute information handled as registered information, and generating supplemental attribute information in which the supplemental pattern is added to the registered information;
an attribute information linking means for generating linked attribute values linking attribute values of attribute information contained respectively in the registered information and the supplemental attribute information;
a hash generating means for converting linked attribute values generated by the attribute information linking means into hash values; and
an information registering means for registering the registered information in a hash table so as to correspond to hash values converted by the hash generating means.

10. An information search method, comprising:
a combination generating step in which a computer generates combinations made by picking out and combining 1 to M attribute information items from evaluation target information having M (where M is 1 or more and an integer) items of attribute information containing attribute values;
an attribute information linking step in which the computer generates linked attribute values linking attribute values of the attribute information contained in each combination, for each generated combination;
a hash generating step in which the computer converts linked attribute values generated in the attribute information linking step into hash values; and,
an information searching step in which the computer searches a hash table in which registered information having one or more attribute information item is stored so as to correspond to hash values converted from the linked attribute values linking the attribute values of attribute information contained in the registered information, and extracts registered information registered so as to correspond to hash values that match any of the hash values converted by the hash generating step.

11. The information search method according to claim 10, wherein the computer generates combinations containing attribute information stipulated by attribute selection information stipulating attribute information used when generating combinations among attribute information contained in the evaluation target information, out of combinations made by picking out and combining 1 to M items of attribute information from the evaluation target information in the combination generating step.

12. The information search method according to claim 11, wherein the attribute selection information is altered attribute information indicating attribute information that was changed from the evaluation target information used in a prior information search.

13. The information search method according to claim 12, further comprising:
a registered information attribute linking step in which the computer inputs registered information and generates information registration values linking attribute values contained in the input registered information;
a registered information hash conversion step in which the computer converts linked attribute values corresponding to the generated registered information into hash values; and
an information registering step in which the computer registers the input registered information in the hash table so as to correspond to the hash values converted in the registered information hash conversion step.

14. The information search method according to claim 13, wherein the computer links the attribute values after arranging the attribute information in a prescribed order, in the attribute information linking step.

15. The information search method according to claim 14, in which the attribute information further contains an attribute name and the computer arranges the attribute information on the basis of the attribute name, in the attribute information linking step.

16. An information search method, comprising:
a supplemental pattern generating step in which a computer inputs registered information having one or more attribute information item containing an attribute value, and generates a supplemental pattern composed of combinations of attribute values of attribute information not contained in the registered information input into the registered information processing means, out of the attribute information handled as registered information, with reference to a pattern storage unit that stores attribute values of attribute information handled as registered information;
an attribute information linking step in which the computer generates linked attribute values linking attribute values of attribute information contained respectively in the registered information and the supplemental attribute information in which the supplemental pattern is added to the registered information;
a hash conversion step in which the computer converts linked attribute values generated by the attribute information linking step into hash values;
an information registering step in which the computer registers the registered information in a hash table so as to correspond to hash values converted in the hash generating step;
an evaluation target information hash conversion step in which the computer inputs evaluation target information containing one or more attribute information item and converts linked attribute values linking attribute values contained in the input evaluation target information into hash values; and
an information searching step in which the computer searches the hash table and extracts registered information registered so as to correspond to hash values matching hash values generated in the evaluation target information hash conversion step.

17. The information search method according to claim 16, wherein the computer links the attribute values after arranging the attribute information in a prescribed order, in the attribute information linking step and the evaluation target information hash conversion step.

18. An information management method, comprising:
a supplemental pattern generating step in which a computer inputs registered information having one or more attribute information item containing an attribute value, and generates a supplemental pattern composed of combinations of attribute values of attribute information not contained in the input registered information, out of the attribute information handled as registered information, with reference to a pattern storage unit that stores attribute values of attribute information handled as the registered information;
an attribute information linking step in which the computer generates linked attribute values linking attribute values of attribute information contained respectively in the registered information and the supplemental attribute information in which the supplemental pattern is added to the registered information;
a hash conversion step in which the computer converts the linked attribute values generated in the attribute information linking step into hash values; and
an information registering step in which the computer registers the registered information in a hash table so as to correspond to hash values converted in the hash conversion step.

19. A computer-readable recording medium on which is recorded a program that causes a computer to execute:
a combination generating process for generating combinations made by picking out and combining 1 to M attribute information items from evaluation target information having M (where M is 1 or more and an integer) items of attribute information containing attribute values;
an attribute information linking process for generating linked attribute values linking attribute values of the attribute information contained in each combination, for each of the generated combinations;
a hash conversion process for converting linked attribute values generated by the attribute information linking process into hash values; and,
an information searching process for searching a hash table in which registered information having one or more attribute information item is stored so as to correspond to supplemental attribute information in which linked attribute values linking attribute values of attribute information contained in the registered information is converted into hash values, and extracting registered information registered so as to correspond to hash values that match any of the hash values converted by the hash conversion process.

20. A computer-readable recording medium on which is recorded a program that causes a computer to execute:
a supplemental pattern generating process for inputting registered information having one or more attribute information item containing an attribute value, and generating a supplemental pattern composed of combinations of attribute values of attribute information not contained in the input registered information, out of the attribute information handled as registered information, with reference to a pattern storage unit that stores attribute values of attribute information handled as registered information;
an attribute information linking process for generating linked attribute values linking attribute values of attribute information contained respectively in the registered information and the supplemental attribute information in which the supplemental pattern is added to the registered information;
a hash conversion process for converting linked attribute values generated by the attribute information linking process into hash values;
an information registering process for registering the registered information in a hash table so as to correspond to hash values converted by the hash generating process;
an evaluation target information hash conversion process for inputting evaluation target information containing one or more attribute information item and converting linked attribute values linking attribute values contained in the input evaluation target information into hash values; and
an information searching process for searching the hash table and extracting registered information registered so as to correspond to hash values matching hash values generated by the evaluation target information hash conversion process.

21. A computer-readable recording medium on which is recorded a program that causes a computer to execute:
a supplemental pattern generating process for inputting registered information having one or more attribute information item containing an attribute value, and generating a supplemental pattern composed of combinations of attribute values of attribute information not contained in the input registered information, out of the attribute information handled as registered information, with reference to a pattern storage unit that stores attribute values of attribute information handled as registered information;
an attribute information linking process for generating linked attribute values linking attribute values of attribute information contained respectively in the registered information and the supplemental attribute information in which the supplemental pattern is added to the registered information;
a hash conversion process for converting linked attribute values generated by the attribute information linking process into hash values; and
an information registering process for registering the registered information in a hash table so as to correspond to hash values converted by the hash generating process.
